(19) United States
(12) Patent Application Publication
(10) Pub. No.: US 2022/0256024 A1
(43) Pub. Date: Aug. 11, 2022

(54) ADSORBABLE ELECTRICAL COUPLING DEVICE HAVING CHARGING AND DATA BACKUP FUNCTIONS

(71) Applicant: MAKTAR INC., New Taipei City (TW)

(72) Inventor: LIANG-HSIN CHEN, New Taipei City (TW)

(21) Appl. No.: 17/335,275

(22) Filed: Jun. 1, 2021

(30) Foreign Application Priority Data
Feb. 8, 2021 (TW) 110104603

(51) Int. Cl. H04M 1/72; H02J 50/10; H04B 1/3888

(52) U.S. Cl. CPC H04M 1/72; H04B 1/3888; H02J 50/10

(57) ABSTRACT

An adsorbable electrical coupling device having charging and data backup functions is provided. An adsorbable coupling component is detachably coupled to a coupling component of an electronic device, such that the adsorbable electrical coupling device is adsorbed on and electrically coupled to the electronic device. When the adsorbable electrical coupling device is electrically coupled to the electronic device, the electronic device receives power from a power supply device of the adsorbable electrical coupling device. A data storage component may backup data of the electronic device or provide data stored in the data storage component to the electronic device. When one or both of power and data are transmitted between the adsorbable electrical coupling device and the electronic device, a user is allowed to manipulate the electronic device to execute other programs.

### CROSS-REFERENCE TO RELATED PATENT APPLICATION

This application claims the benefit of priority to Taiwan Patent Application No. 110104603, filed on Feb. 8, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a transmission wire, and more particularly to an adsorbable electrical coupling device having charging and data backup functions that is capable of synchronously charging a mobile phone and backuping data of the mobile phone when the adsorbable electrical coupling device is being adsorbed on the mobile phone.

### BACKGROUND OF THE DISCLOSURE

When a mobile phone has insufficient power, the mobile phone needs to be charged by a charging stand. However, conventional charging stands are large in size. If a user intends to use the mobile phone that is being charged by the conventional charging stand, both the mobile phone and the charging stand need to be held in hands of the user, which can be very inconvenient.

In order to solve the above problem, a back clip power bank is developed. However, the back clip power bank is integrally with the mobile phone and disposed on a backside surface of the mobile phone. As a result, the aesthetics of the mobile phone is affected, and the mobile phone cannot be fitted with a protective case of the user's liking.

### SUMMARY OF THE DISCLOSURE

In response to the above-referenced technical inadequacies, the present disclosure provides an adsorbable electrical coupling device having charging and data backup functions, which is adsorbed on a surface of an electronic device. The adsorbable electrical coupling device having the charging and data backup functions includes an adsorbable coupling component, a power supply component, a data storage component, and a main controller. When the electronic device needs to be charged or data of the electronic device needs to be backed up, the adsorbable coupling component is detachably coupled to a coupling component of the electronic device such that the adsorbable electrical coupling device is adsorbed on the electronic device and electrically coupled to the electronic device. The power supply component is configured to supply power to the electronic device to charge the electronic device when the adsorbable electrical coupling device is electrically coupled to the electronic device. The data storage component is configured to receive the data from the electronic device and backup the data of the electronic device, and/or provide data stored in the data storage component to the electronic device. The main controller is connected to the power supply component and the data storage component. The main controller is configured to control the data storage component to transmit or receive the data, and determine a coupling state between the adsorbable electrical coupling device and the electronic device. The main controller is configured to control the power supply component to supply the power to the electronic device when the adsorbable electrical coupling device is electrically coupled to the electronic device. When one or both of power and data are transmitted between the adsorbable electrical coupling device and the electronic device, a user is allowed to manipulate the electronic device to execute other programs.

In certain embodiments, the power and the data is synchronously or asynchronously transmitted between the data storage component and electronic device.

In certain embodiments, the adsorbable electrical coupling device having the charging and data backup functions further includes an adsorbable carrier. The adsorbable coupling component is disposed on the adsorbable carrier or integrally formed with the adsorbable carrier.

In certain embodiments, the power supply component and the data storage component are disposed inside the adsorbable carrier.

In certain embodiments, the adsorbable carrier has a slot. Two terminals of a transmission wire are respectively inserted into the slot of the adsorbable carrier and a slot of a power supply device. The power is supplied from the power supply device through the transmission wire to the power supply component.

In certain embodiments, the data storage component receives the data from the electronic device and/or provides the data stored in the data storage component to the electronic device, through the transmission wire.

In certain embodiments, the adsorbable electrical coupling device having the charging and data backup functions further includes a wireless transmission module. The wireless transmission module is wirelessly connected to the electronic device and connected to the data storage component. The data is wirelessly transmitted between the data storage component and the electronic device via the wireless transmission module.

In certain embodiments, the electronic device includes a mobile device and the mobile device includes a mobile phone.

In certain embodiments, a magnet included in the adsorbable coupling component of the adsorbable electrical coupling device is coupled to a magnet included in the coupling component of the electronic device, and a coil included in the adsorbable coupling component is electrically coupled to a coil included in the coupling component.

In certain embodiments, the electronic device is detachably covered by a protective case. The coupling component is disposed on the protective case. The adsorbable electrical coupling device is adsorbed on the protective case and electrically coupled to the electronic device.

As described above, the present disclosure provides the adsorbable electrical coupling device. The adsorbable coupling component (such as the magnet) is coupled to the coupling component of the mobile phone (such as the magnet), such that the adsorbable electrical coupling device is adsorbed on the mobile phone. Under this condition, the circuit component of the adsorbable carrier is electrically connected to the circuit component of the mobile phone, such that the power can be transmitted between the adsorbable electrical coupling device and the mobile phone. For example, the mobile phone is charged by the power supplied from the adsorbable electrical coupling device. During, before, and after the mobile phone or the adsorbable electrical coupling device is charged, the adsorbable electrical coupling device can receive the data from the mobile phone and backup the data, or transmit the data to the mobile phone for backing up the data, in a wired or wireless manner Therefore, when one or both of power and data are transmitted between the adsorbable electrical coupling device and the electronic device, the user can easily hold the mobile phone with their hands and manipulate the mobile phone to execute other programs.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic front view of an adsorbable electrical coupling device that is being adsorbed on a mobile phone according to an embodiment of the present disclosure;

FIG. 2 is a schematic side view of an induction reaction between the adsorbable electrical coupling device and a coupling component of the mobile phone according to the embodiment of the present disclosure;

FIG. 3 is a block diagram of circuit components of data and power being transmitted between the adsorbable electrical coupling device and an electronic device according to the embodiment of the present disclosure;

FIG. 4 is a schematic back view of the adsorbable electrical coupling device being adsorbed on the mobile phone according to the embodiment of the present disclosure;

FIG. 5 is a schematic side view of the adsorbable electrical coupling device being adsorbed on the mobile phone according to the embodiment of the present disclosure;

FIG. 6 is a block diagram of the adsorbable electrical coupling device that transmits power to or from the electronic device and transmits power to or from the an external power supply according to the embodiment of the present disclosure;

FIG. 7 is a block diagram of the adsorbable electrical coupling device that wirelessly transmits data and power to or from the electronic device and transmits power to or from the external power supply device according to the embodiment of the present disclosure;

FIG. 8 is a block diagram of the adsorbable electrical coupling device that transmits data and power to or from the electronic device, transmits power to or from the external power supply device, and transmits data to or from a cloud server according to the embodiment of the present disclosure.

FIG. 9 is a first schematic plan view of an adsorbable coupling component of an adsorbable carrier of an adsorbable electrical coupling device according to an embodiment of the present disclosure;

FIG. 10 is a second schematic plan view of an adsorbable coupling component of an adsorbable carrier of an adsorbable electrical coupling device according to an embodiment of the present disclosure; and

FIG. 11 is a third schematic plan view of an adsorbable coupling component of an adsorbable carrier of an adsorbable electrical coupling device according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the protective case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

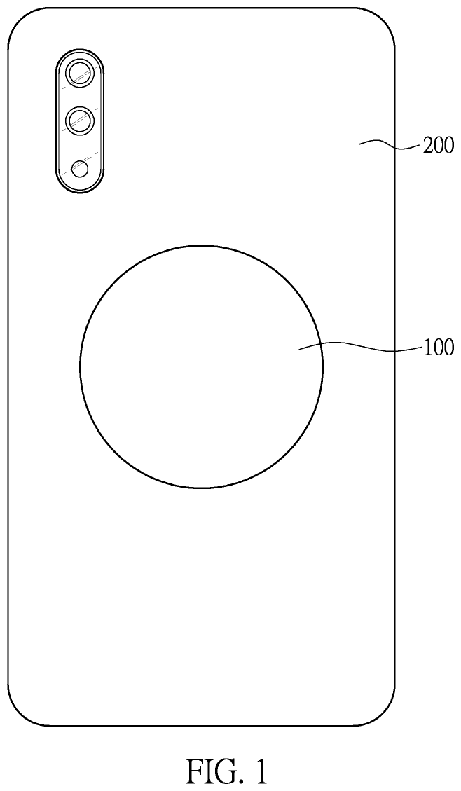

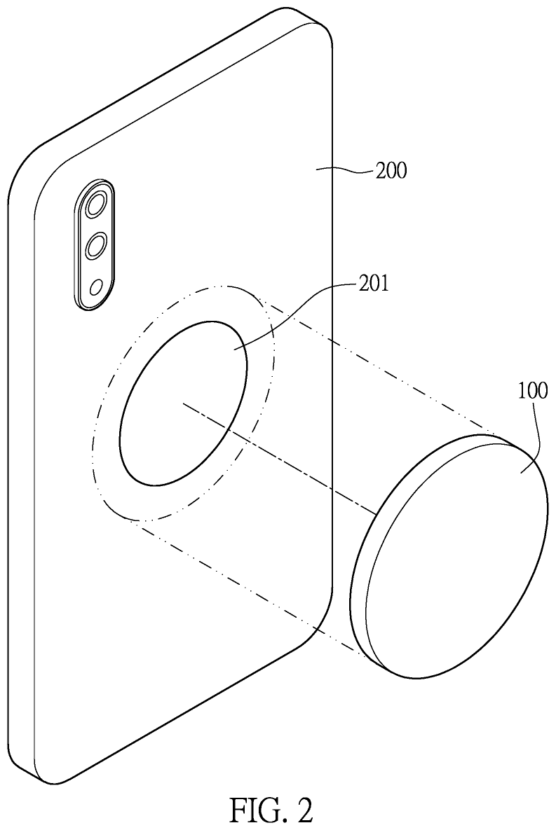

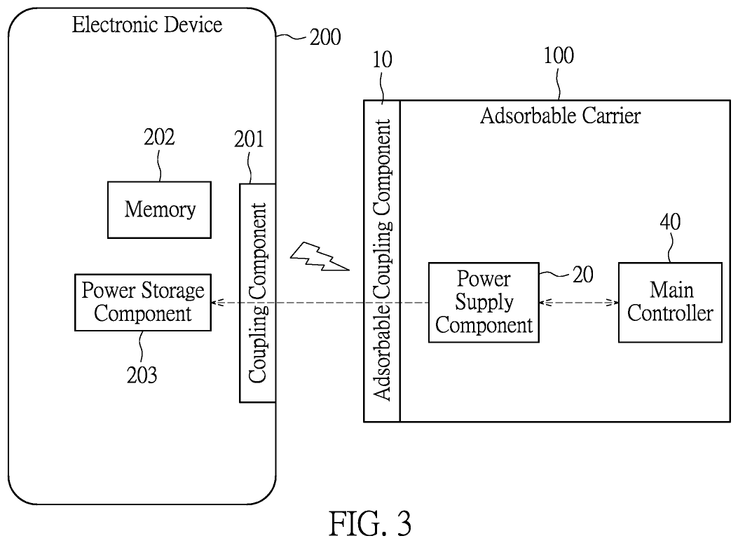

Reference is made to FIGS. 1 to 3, in which FIG. 1 is a schematic front view of an adsorbable electrical coupling device that is being adsorbed on a mobile phone according to an embodiment of the present disclosure, FIG. 2 is a schematic side view of the adsorbable electrical coupling device and a coupling component of the mobile phone between which induction occurs according to the embodiment of the present disclosure, and FIG. 3 is a block diagram of circuit components of the adsorbable electrical coupling device and an electronic device between which data and power is transmitted according to the embodiment of the present disclosure.

In the embodiment, the adsorbable electrical coupling device may include a power supply component 20 and a main controller 40, such that the adsorbable electrical coupling device has a charging function.

It is worth noting that, the adsorbable electrical coupling device may further include an adsorbable coupling component 10. The adsorbable coupling component 10 may be mounted on an adsorbable carrier 100 or integrally formed with the adsorbable carrier 100. The adsorbable coupling component 10 of the adsorbable electrical coupling device may be coupled to a coupling component 201 of an electronic device 200, such that the adsorbable carrier 100 is adsorbed on the electronic device 200. Under this condition, a circuit component such as a coil of the adsorbable electrical coupling device is electrically coupled to a circuit component such as a coil of the electronic device 200. For example, the adsorbable coupling component 10 and the coupling component 201 may be magnets, and the electronic device 200 may be a mobile phone or other mobile devices, but the present disclosure is not limited thereto.

In practice, the adsorbable carrier 100 of the adsorbable electrical coupling device may be detachably adsorbed on the electronic device 200, such as the mobile phone, in a mechanical coupling manner, an adhesive manner, or other manners. For example, the electronic device 200 such as the mobile phone is detachably covered by a protective case. The coupling component 201 may be an engaging protrusion on the protective case, and the adsorbable coupling component 10 may be an engaging groove. Alternatively, the coupling component 201 may be an engaging groove on the protective case, and the adsorbable coupling component 10 may be an engaging protrusion. The engaging groove is matched with the engaging protrusion and can be engaged with the engaging protrusion. Therefore, the adsorbable carrier 100 of the adsorbable electrical coupling device can be detachably attached on the protective case, such that the circuit component of the adsorbable electrical coupling device is placed near or directly in contact with the circuit component of the electronic device 200. As a result, the adsorbable carrier 100 of the adsorbable electrical coupling device is electrically coupled to the electronic device 200.

The main controller 40 may be connected to the power supply component 20 and configured to control the power supply component 20. For example, the power supply component 20 may be a battery, but the present disclosure is not limited thereto. The main controller 40 may determine a coupling state between the adsorbable coupling component 10 and the coupling component 201. When the adsorbable carrier 100 of the adsorbable electrical coupling device is adsorbed on a surface of the electronic device 200, the power supply component 20 inside the adsorbable carrier 100 of the adsorbable electrical coupling device may be electrically coupled to a power storage component 203 of the electronic device 200. Under this condition, the main controller 40 may control the power supply component 20 to supply power to the power storage component 203, such as a battery of the electronic device 200 to charge the power storage component 203.

It is worth noting that, when the adsorbable electrical coupling device of the present disclosure is used to charge the mobile phone, a user does not need to place the mobile phone on a charging stand, or hold the mobile phone and a charging stand that is large and heavy in size at the same time with their hands. Therefore, when the mobile phone is being charged, the user can conveniently use the mobile phone. The adsorbable carrier 100 of the adsorbable electrical coupling device is lightweight and can be adsorbed on the electronic device 200. When one or both of power and data are transmitted between the adsorbable electrical coupling device and the electronic device 200, the user can manipulate the electronic device to execute other programs.

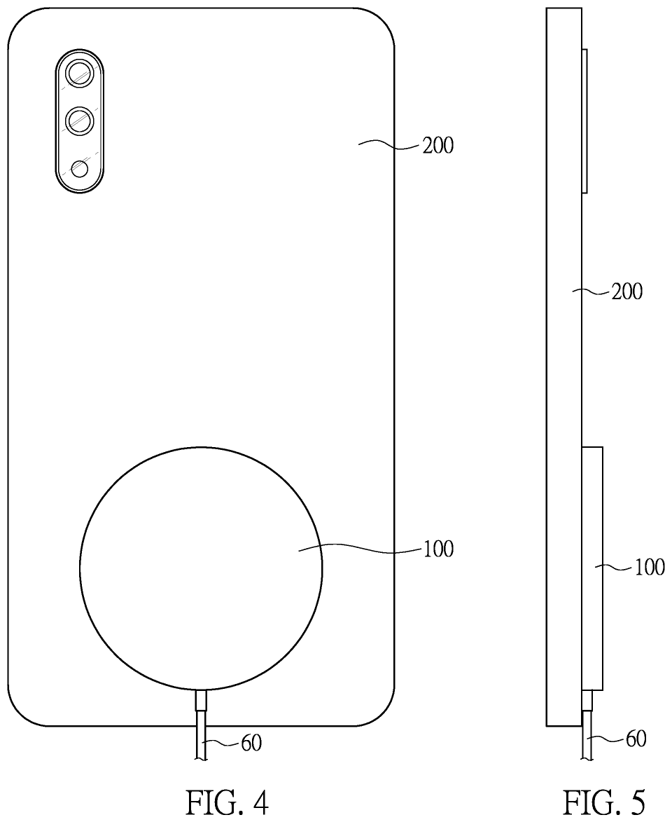

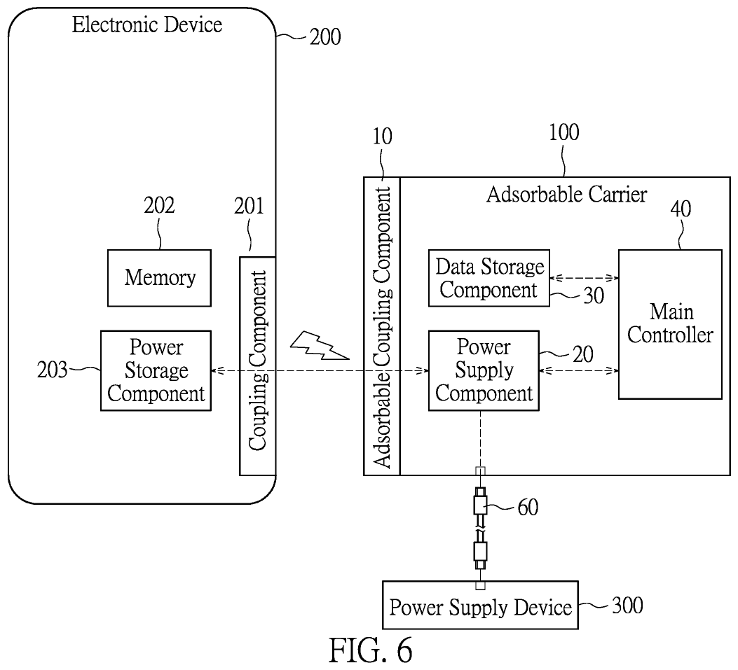

Reference is made to FIGS. 4 to 6, in which FIG. 4 is a schematic back view of the mobile phone on which the adsorbable electrical coupling device is adsorbed according to the embodiment of the present disclosure, FIG. 5 is a schematic side view of the mobile phone on which the adsorbable electrical coupling device is adsorbed according to the embodiment of the present disclosure, and FIG. 6 is a block diagram of the adsorbable electrical coupling device that transmits power to or from the electronic device and an external power supply device and transmits data to or from the electronic device according to the embodiment of the present disclosure. The same descriptions are not repeated herein.

As shown in FIGS. 1 and 2, the adsorbable carrier 100 is adsorbed at a middle position on the backside surface of the electronic device 200 such as the mobile phone. As shown in FIGS. 4 and 5, the adsorbable carrier 100 is adsorbed on the backside surface of the electronic device 200, and located near a lower edge of the backside surface of the electronic device 200. In practice, the adsorbable carrier 100 may be adsorbed on a side surface of the electronic device 200 or at an upper position on the backside surface of the electronic device 200, or in other positions. A position of the adsorbable carrier 100 on the electronic device 200 may depend on a position of the coupling component 201 on the electronic device 200. It should be known that, a size and a shape of the attachable carrier 100, the position of the adsorbable carrier 100, and the position of the coupling component 201 are only exemplified in the embodiment, and the present disclosure is not limited thereto.

The adsorbable electrical coupling device of the embodiment may not only include the power supply component 20 and the main controller 40, but also include a data storage component 30. In the embodiment, the power supply component 20, the data storage component 30, and the main controller 40 are disposed inside the adsorbable carrier 100. Therefore, the adsorbable electrical coupling device functions to transmit data and power. In practice, the power supply component 20 may only have a single function of transmitting data or power.

The adsorbable carrier 100 may have a slot, as shown in the figure. A plug of one terminal of a transmission wire 60 may be inserted into the slot of the adsorbable carrier 100, and a plug of the other terminal of the transmission wire 60 may be inserted into a slot of a power supply device 300. For example, the plug is a USB plug and the slot is a USB slot, and the slot of the adsorbable carrier 100 may be at a position near the lower edge of the adsorbable carrier 100, but the present disclosure is not limited thereto.

The power supply component 20 may be electrically connected to the power supply device 300 through the transmission wire 60. When the power supply component 20 of the adsorbable electrical coupling device is electrically connected to the power supply device 300 through the transmission wire 60 (and power stored in the power supply component 20 is lower than a power threshold), the power supply component 20 may receive and store power from the power supply device 300 through the transmission wire 60. For example, the power supply device 300 may be a charging stand or other external power supply devices. If necessary, power stored in or obtained by the power supply component 20 may be supplied to other circuit components of the adsorbable electrical coupling device such as the main controller 40 and the data storage component 30, and may be supplied to the electronic device 200 such as the mobile phone.

As described above, the two plugs of the two terminals of the transmission wire 60 are respectively inserted into the slot of the power supply device 300 and the slot of the adsorbable carrier 100, and the power is transmitted between the adsorbable electrical coupling device and the power supply device 300 through the transmission wire 60, but the present disclosure is not limited thereto. In practice, the two plugs of the two terminals of the transmission wire 60 may respectively be inserted into a slot of the electronic device 200 and the slot of the adsorbable carrier 100. Under this condition, the data storage component 30 inside the adsorbable carrier 100 of the adsorbable electrical coupling device is electrically connected to a memory 202 or other storage units of the electronic device 200 through the transmission wire 60.

The main controller 40 may be connected to the data storage component 30 and configured to control the data storage component 30. When, before or after the electronic device 200 is charged by the adsorbable electrical coupling device, the main controller 40 may control the data storage component 30 to receive data from the memory 202 or other storage units of the electronic device 200 through the transmission wire 60 and store the received data, or transmit the data stored in the data storage component 30 to the electronic device 200.

As described above, the adsorbable carrier 100 has only one slot. Under this condition, when the power is transmitted between the power supply component 20 of the adsorbable electrical coupling device and the power supply device 300 through the transmission wire 60, the data cannot be transmitted between the data storage component 30 of the adsorbable electrical coupling device and the memory 202 of the electronic device 200 through the transmission wire 60, vice versa. Therefore, in practice, the adsorbable carrier 100 may have two slots or more slots. One terminal of the transmission wire 60 may be inserted into one of the slots, and one terminal of a wire may be inserted into another one of the slots. The other terminal of the transmission wire 60 may be inserted into the slot of the power supply device 300, and the other terminal of the wire may be inserted into the slot of the electronic device 200. Under this condition, when the power is transmitted between the power supply component 20 and the power supply device 300 through the transmission wire 60, the data can be transmitted between the data storage component 30 and the memory 202 through the wire, vice versa.

In the embodiment, the power supply component 20, the data storage component 30, and the main controller 40 are disposed inside the adsorbable carrier 100, but the present disclosure is not limited thereto. In practice, the power supply component 20, the data storage component 30, and the main controller 40 may be disposed inside an external device outside the adsorbable carrier 100. The electronic device 200 such as the mobile phone may be connected to the external device through the transmission wire 60. Under this condition, the electronic device 200 may transmit power to or receive power from the external device through the transmission wire 60. At the same time or different times, the electronic device 200 may wirelessly transmit data to or receive data from the external device.

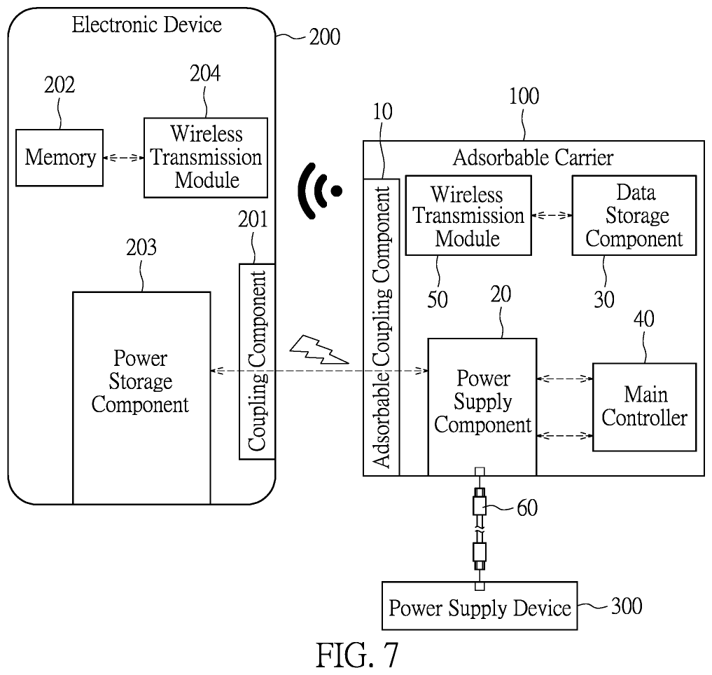

Reference is made to FIG. 7, which is a block diagram of the adsorbable electrical coupling device that wirelessly transmits data and power to or from the electronic device and transmits power to or from the external power supply device according to the embodiment of the present disclosure. The same descriptions are not repeated herein.

In the embodiment, the adsorbable electrical coupling device not only includes the power supply component 20, the data storage component 30, and the main controller 40, but also includes a wireless transmission module 50. The power supply component 20, the data storage component 30, the main controller 40, and the wireless transmission module 50 may be disposed inside the adsorbable carrier 100. The wireless transmission module 50 may be connected to the data storage component 30 and wirelessly connected to a wireless transmission module 204 of the electronic device 200.

The wireless transmission module 50 may wirelessly transmit data stored in the data storage component 30 inside the adsorbable carrier 100 of the adsorbable electrical coupling device to the wireless transmission module 204 of the electronic device 200. Then, the wireless transmission module 204 may wirelessly transmit the data to the memory 202 or other storage units of the electronic device 200.

Conversely, the wireless transmission module 204 may wirelessly transmit the data stored in or obtained by the memory 202 or other storage units of the electronic device 200 to the wireless transmission module 50 of the adsorbable electrical coupling device. Then, the wireless transmission module 50 may wirelessly transmit the data to the data storage component 30, such that the data is stored in the data storage component 30.

When, before or after the data is transmitted between the adsorbable electrical coupling device and the electronic device 200, the power supply component 20 of the adsorbable electrical coupling device may be charged by the power supply device 300, and/or the power storage component 203 of the electronic device 200 may be charged by the power supply component 20.

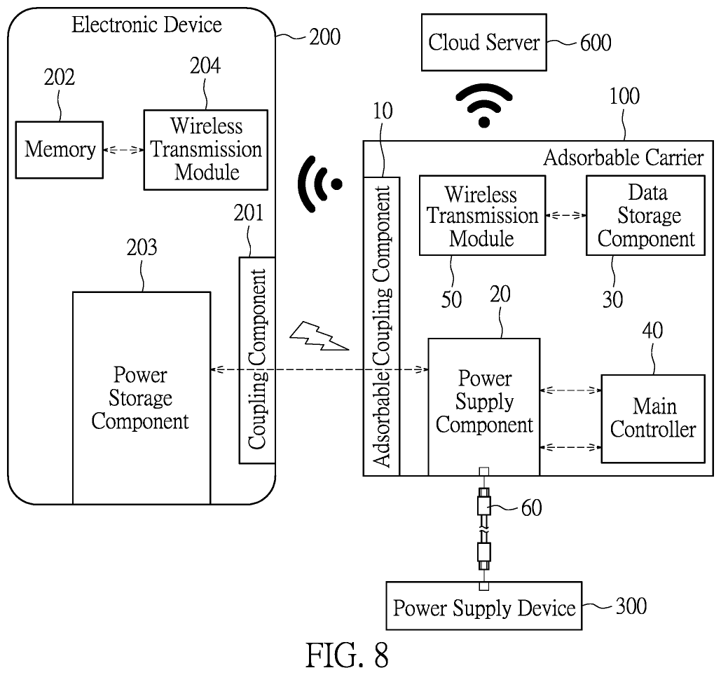

Reference is made to FIG. 8, which is a block diagram of the adsorbable electrical coupling device that transmits data and power to or from the electronic device, transmits power to or from the external power supply device and transmits data to or from a cloud server according to the embodiment of the present disclosure. The same descriptions are not repeated herein.

Data may be transmitted between the wireless transmission module 50 of the adsorbable electrical coupling device and the wireless transmission module 204 of the electronic device 200. In addition, data may be transmitted between the wireless transmission module 50 and a cloud server 600 or other external devices in a wired or wireless manner.

For example, the data of the cloud server 600 may be transmitted to the data storage component 30 of the adsorbable electrical coupling device through the wireless transmission module 50 of the adsorbable electrical coupling device. Next, the data may be stored in the data storage component 30. In addition, the data of the cloud server 600 may be transmitted to the memory 202 of the electronic device 200 through the wireless transmission module 204 of the electronic device 200. Then, the data of the cloud server 600 may be stored in the memory 202 to back up the data.

Conversely, the wireless transmission module 50 of the adsorbable electrical coupling device may receive data from (the memory 202) of the electronic device 200 through the wireless transmission module 204 of the electronic device 200. Then, the data of the electronic device 200 may be transmitted from the wireless transmission module 50 to be stored in the data storage component 30 of the adsorbable electrical coupling device, so as to back up the data via the cloud server 600 and/or other external devices.

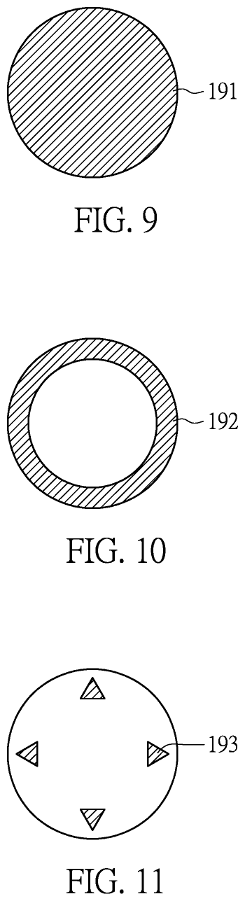

Reference is made to FIG. 9, which is a first schematic plan view of an adsorbable coupling component of an adsorbable carrier of an adsorbable electrical coupling device according to an embodiment of the present disclosure.

For example, in the embodiment, the adsorbable carrier of the adsorbable electrical coupling device has a circular shape, but the present disclosure is not limited thereto. In practice, the adsorbable carrier of the adsorbable electrical coupling device may have a square shape, a triangular shape or other shapes. An adsorbable coupling component 191 of the adsorbable carrier may include a magnet, and a bottom surface of the adsorbable carrier may be entirely covered by the magnet, but the present disclosure is not limited thereto.

Reference is made to FIG. 10, which is a second schematic plan view of an adsorbable coupling component of an adsorbable carrier of an adsorbable electrical coupling device according to an embodiment of the present disclosure.

As shown in FIG. 10, an adsorbable coupling component 192 of the adsorbable electrical coupling device may include a magnet, and an inner periphery of the bottom surface of the adsorbable carrier may be covered by the magnet, but the present disclosure is not limited thereto.

Reference is made to FIG. 11, which is a third schematic plan view of an adsorbable coupling component of an adsorbable carrier of an adsorbable electrical coupling device according to an embodiment of the present disclosure.

As shown in FIG. 11, the adsorbable electrical coupling device may include any suitable number of adsorbable coupling components 193. The adsorbable coupling components 193 may include magnets and may be arranged on the adsorbable carrier in a regular manner, such as in an array or in an irregular manner. The adsorbable coupling components 193 may have a triangular shape, but the present disclosure is not limited thereto. In practice, the adsorbable coupling component 193 may have a circular shape, a square shape, a diamond shape or other shapes.

In summary, the present disclosure provides the adsorbable electrical coupling device. The adsorbable coupling component (such as the magnet) is coupled to the coupling component of the mobile phone (such as the magnet), such that the adsorbable electrical coupling device is adsorbed on the mobile phone. Under this condition, the circuit component of the adsorbable carrier is electrically connected to the circuit component of the mobile phone such that the power can be transmitted between the adsorbable electrical coupling device and the mobile phone. For example, the mobile phone is charged by the power supplied from the adsorbable electrical coupling device. When, before, after the mobile phone or the adsorbable electrical coupling device is charged, the adsorbable electrical coupling device can receive the data from the mobile phone and backup the data, or transmit the data to the mobile phone for backing up the data, in the wired or wireless manner. Therefore, when one or both of power and data are transmitted between the adsorbable electrical coupling device and the electronic device, the user can easily hold the mobile phone in their hands and manipulate the mobile phone to execute other programs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An attachable electrical coupling device having charging and data backup functions, which is adsorbed on a surface of an electronic device, the adsorbable electrical coupling device having the charging and data backup functions comprising:
an adsorbable coupling component, wherein, when the electronic device needs to be charged or data of the electronic device needs to be backed up, the adsorbable coupling component is detachably coupled to a coupling component of the electronic device, such that the adsorbable electrical coupling device is adsorbed on the electronic device and electrically coupled to the electronic device;
a power supply component configured to supply power to the electronic device to charge the electronic device when the adsorbable electrical coupling device is electrically coupled to the electronic device;
a data storage component configured to receive the data from the electronic device and backup the data of the electronic device, and/or provide data stored in the data storage component to the electronic device; and
a main controller connected to the power supply component and the data storage component, configured to control the data storage component to transmit or receive the data and determine a coupling state between the adsorbable electrical coupling device and the electronic device, and configured to control the power supply component to supply the power to the electronic device when the adsorbable electrical coupling device is electrically coupled to the electronic device;
wherein, when one or both of the power and the data are transmitted between the adsorbable electrical coupling device and the electronic device, a user is enabled to manipulate the electronic device to execute other programs.

2. The adsorbable electrical coupling device having the charging and data backup functions according to claim 1, wherein the power and the data are synchronously or asynchronously transmitted between the data storage component and the electronic device.

3. The adsorbable electrical coupling device having the charging and data backup functions according to claim 1, further comprising:
an adsorbable carrier, wherein the adsorbable coupling component is disposed on the adsorbable carrier or integrally formed with the adsorbable carrier.

4. The adsorbable electrical coupling device having the charging and data backup functions according to claim 3, wherein the power supply component and the data storage component are disposed inside the adsorbable carrier.

5. The adsorbable electrical coupling device having the charging and data backup functions according to claim 4, wherein the adsorbable carrier has a slot, two terminals of a transmission wire are respectively inserted into the slot of the adsorbable carrier and a slot of a power supply device, and power is supplied from the power supply device through the transmission wire to the power supply component.

6. The adsorbable electrical coupling device having the charging and data backup functions according to claim 5, wherein the data storage component receives the data from the electronic device and/or provides the data stored in the data storage component to the electronic device, through the transmission wire.

7. The adsorbable electrical coupling device having the charging and data backup functions according to claim 1, further comprising:
a wireless transmission module wirelessly connected to the electronic device and connected to the data storage component, wherein the data is wirelessly transmitted between the data storage component and the electronic device via the wireless transmission module.

8. The adsorbable electrical coupling device having the charging and data backup functions according to claim 1, wherein the electronic device includes a mobile device, and the mobile device includes a mobile phone.

9. The adsorbable electrical coupling device having the charging and data backup functions according to claim 1, wherein a magnet included in the adsorbable coupling component of the adsorbable electrical coupling device is coupled to a magnet included in the coupling component of the electronic device, and a coil included in the adsorbable coupling component is electrically coupled to a coil included in the coupling component.

10. The adsorbable electrical coupling device having the charging and data backup functions according to claim 1, wherein the electronic device is detachably covered by a protective case, the coupling component is disposed on the protective case, and the adsorbable electrical coupling device is adsorbed on the protective case and electrically coupled to the electronic device.
